(19) United States
(12) Patent Application Publication
(10) Pub. No.: US 2018/0176400 A1
(43) Pub. Date: Jun. 21, 2018

(54) IMAGE READING APPARATUS AND READING METHOD

(71) Applicant: CANON KABUSHIKI KAISHA, Tokyo (JP)

(72) Inventor: Hiromu Shimizu, Kashiwa-shi (JP)

(21) Appl. No.: 15/839,558

(22) Filed: Dec. 12, 2017

(30) Foreign Application Priority Data
Dec. 16, 2016 (JP) 2016-244055

(51) Int. Cl. H04N 1/00

(52) U.S. Cl. CPC H04N 1/00708; H04N 1/00034; H04N 1/00042; H04N 1/00766; H04N 1/00092; H04N 1/00737; H04N 1/00005

(57) ABSTRACT

An image reading apparatus includes an original table on which an original is to be placed, an original pressing member configured to press the placed original toward the original table, a reading unit configured to read light reflected from the original in a plurality of colors while irradiating the original placed on the original table with light and moving a reading position in a predetermined direction, and a storage unit configured to store color data of the original pressing member. The image reading apparatus determines whether or not the original is protruding from the original table based on output values of the plurality of colors, which are read by the reading unit in a region outside a maximum standard size of the original in a direction intersecting with a direction in which the reading unit is moved, and on the color data of the original pressing member.

### BACKGROUND OF THE INVENTION

### Field of the Invention

The present invention relates to an image reading apparatus and an imager reading method.

### Description of the Related Art

There has been known an image reading apparatus configured to read image data in a main scanning direction of an original placed on an original table glass while a reading unit is conveyed in a sub-scanning direction. The image reading apparatus detects a size of the original based on the read image data, for example. Specifically, the image reading apparatus detects an original edge (original end) based on the image data to determine the original size based on a result of the detection.

When an original (protruding original) having a size that protrudes from the original table glass is placed on the original table glass, the read image data is entirely an image of the original, and there is no image data of an original pressing member that is mounted on a back surface side (original table glass opposing surface side) of a platen (platen cover). That is, the original pressing member is not read, and the read image data does not have an image of a boundary between the original and the original pressing member. Therefore, the image data does not have an original edge part. In this case, the image reading apparatus may falsely detect the image data present in the original as an original edge, and thus may falsely detect an original size.

For example, an apparatus disclosed in Japanese Patent Application Laid-open No. 2009-164808 includes a frame at a peripheral edge of the original table glass. At a boundary between the original table glass and the frame, a step difference is formed so that the frame is located at a higher level and the original table glass is located at a lower level. The apparatus can determine a state in which the original is climbing over the frame, that is, whether or not a protruding original is placed, based on the image data around the boundary between the original table glass and the frame.

In the apparatus disclosed in Japanese Patent Application Laid-open No. 2009-164808, however, the step difference is formed at the boundary between the original table glass and the frame, and hence the original may be raised around the boundary when the protruding original is placed. As a result, an image sensor located around the boundary may not be able to focus on the original. Thus, the read image may be blurred, and image deterioration may be caused.

### SUMMARY OF THE INVENTION

An image reading apparatus according to the present invention includes: an original table on which an original is to be placed; an original pressing member configured to press the original toward the original table; a sensor configured to read the original at a reading position to output a plurality of pieces of color data; an illumination unit configured to illuminate the reading position; a movement unit configured to move the reading position in a first direction; a storage unit configured to store color data of the original pressing member; and a processor configured to determine a size of the original based on the color data output from the sensor, wherein the processor is configured to determine whether the original is protruding from a reading region based on the plurality of pieces of color data in a region outside the reading region in a second direction that is orthogonal to the first direction, the reading region corresponding to a maximum size among sizes that are able to be determined by the processor, and on the stored color data.

Further features of the present invention will become apparent from the following description of exemplary embodiments (with reference to the attached drawings).

### BRIEF DESCRIPTION OF THE DRAWINGS

FIG. 1 is a schematic vertical sectional view for illustrating an example of a configuration of an image forming system of a first embodiment of the present invention.

FIG. 2 is a schematic vertical sectional view for illustrating an example of a configuration of an image reading apparatus.

FIG. 3 is a schematic view for illustrating the image reading apparatus as viewed from the top under a state in which a platen is opened.

FIG. 4 is a block diagram for illustrating a functional configuration of the image forming system.

FIG. 5 is a flow chart for illustrating an example of a processing procedure from original reading to image formation in the image forming system.

FIG. 6 is a flow chart for illustrating details of processing of Step S507 illustrated in FIG. 5.

FIG. 7A, FIG. 7B, and FIG. 7C are graphs for showing comparison between a dat value and a ref value in protruding original determination processing.

FIG. 8 is a flow chart for illustrating details of processing of Step S509 illustrated in FIG. 5.

FIG. 9 is a graph for showing a relationship among a luminance value f(x) and g(x), h(x), and i(x) calculated in respective determinations in original size detection processing.

FIG. 10 is a flow chart for illustrating an example of a processing procedure of protruding original determination processing in an image reading apparatus according to a second embodiment of the present invention.

### DESCRIPTION OF THE EMBODIMENTS

Now, a description is given by means of an example of a case in which the present invention is applied to an image forming system. The technical scope of the present invention is defined by the appended claims, and is not limited by individual embodiments described below.

### First Embodiment

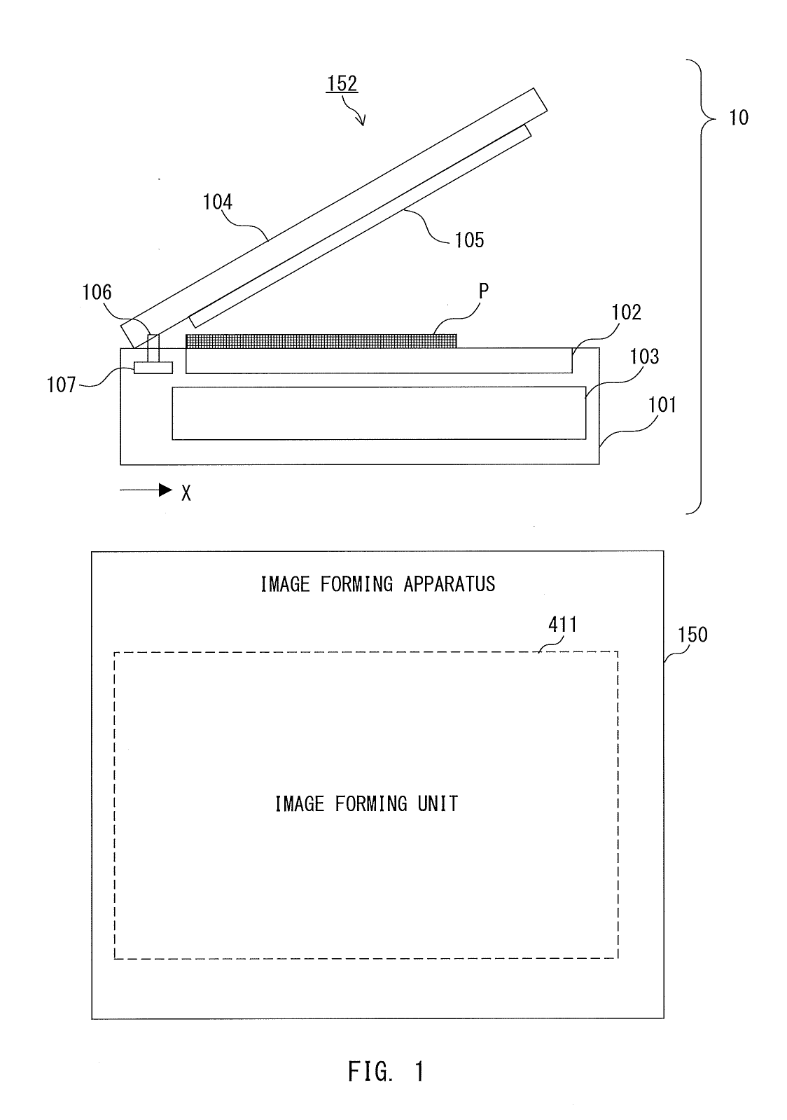

FIG. 1 is a schematic vertical sectional view for illustrating an example of a configuration of an image forming system according to a first embodiment of the present invention. An image forming system 152 includes an image reading apparatus 10 and an image forming apparatus 150. An arrow X of FIG. 1 represents a main scanning direction used when the image reading apparatus 10 reads an original P. The main scanning direction is a direction in which photoelectric conversion elements are arrayed in a sensor, and is a direction orthogonal to a direction in which a reading unit is moved.

The image forming apparatus 150 includes an image forming unit 411 configured to form an image by an electrophotographic printing method. The image forming unit 411 includes a photosensitive member, an exposure device, a developing device, a transfer unit, and a fixing device. The exposure device is configured to form an electrostatic latent image on the photosensitive member based on read data (image data) generated by the image reading apparatus 10 reading an original P. The developing device is configured to form a developer image on the photosensitive member by developing the electrostatic latent image formed on the photosensitive member by a developer. The transfer unit is configured to transfer the developer image formed on the photosensitive member onto a given recording medium (for example, a sheet of paper). The fixing device is configured to fix the developer image transferred onto the recording medium to the recording medium. With the above-mentioned configuration, the image forming unit 411 forms an image corresponding to the image data on the recording medium.

The image reading apparatus 10 includes a casing 101, an original table glass 102 serving as an original table on which an original is placed when an image on the original is read, a reading unit 103, a platen (platen cover) 104, an original pressing member 105, a platen open/close detection flag 106, and a platen open/close detection sensor 107. The original pressing member 105 is mounted on a back surface side (surface side opposing the original table glass 102) of the platen 104.

The original table glass 102 is an original table on which the original P is placed. The reading unit 103 reads the original P placed on the original table (on the original table glass 102).

The platen 104 presses the original P placed on the original table glass 102 against the original table glass 102 via the original pressing member 105. The platen 104 is configured such that an angle of the platen 104 with respect to the original table glass 102 is changeable in order to enable the original P to be placed on the original table glass 102 or enable the original P to be removed from the top of the original table glass 102. The original pressing member 105 has a white surface formed so that a region outside an original region is prevented from being blackened when the original P is read.

The platen open/close detection sensor 107 is configured to switch its ON/OFF state when the platen open/close detection flag 106 moves depending on whether the platen 104 is in an open state or a closed state. Depending on the state of the platen open/close detection sensor 107, whether or not the original P placed on the original table glass 102 is in a state of being pressed against the original table glass 102 by the original pressing member 105 (whether or not the platen 104 is in the closed state) can be detected.

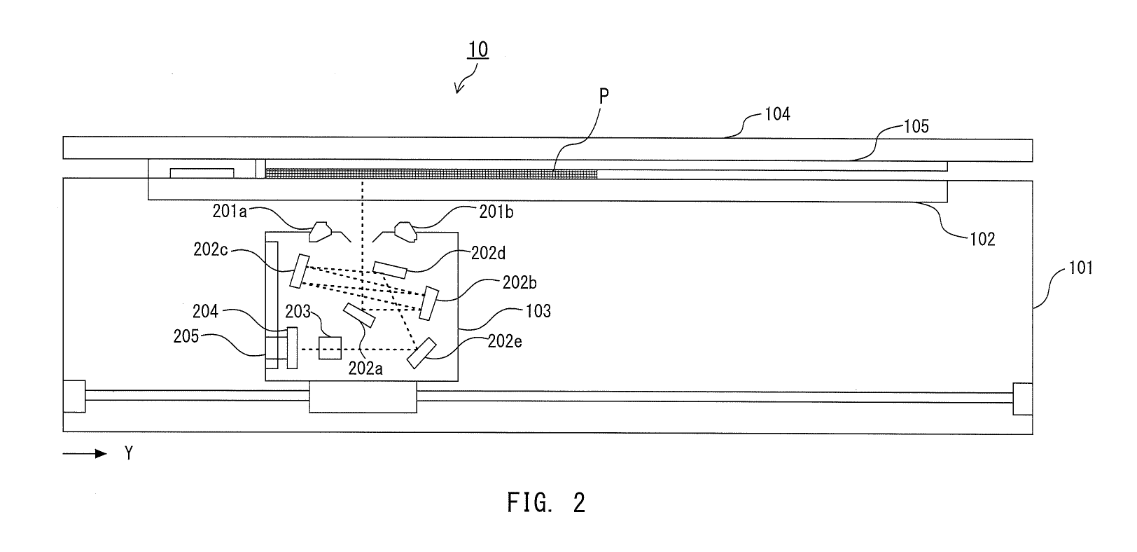

FIG. 2 is a schematic vertical sectional view for illustrating an example of the configuration of the image reading apparatus 10. The reading unit 103 includes illumination units 201a and 201b configured to irradiate a surface of the original placed on the original table with light, reflective mirrors 202a, 202b, 202c, 202d, and 202e configured to reflect the light reflected from the original surface, and an imaging lens 203. The reading unit 103 further includes a sensor 204 including a photoelectric conversion element, for example, a charge coupled device (CCD), and a sensor board 205 having the photoelectric conversion element 204 mounted thereon.

When the original P is read, the reading unit 103 is moved in an arrow Y direction of FIG. 2 (sub-scanning direction) to read the original P. That is, in the image reading apparatus 10, the light reflected from the original P is read in a plurality of colors when the reading position is moved in a predetermined direction (sub-scanning direction). The arrow Y direction is a direction orthogonal to an arrow X direction of FIG. 1.

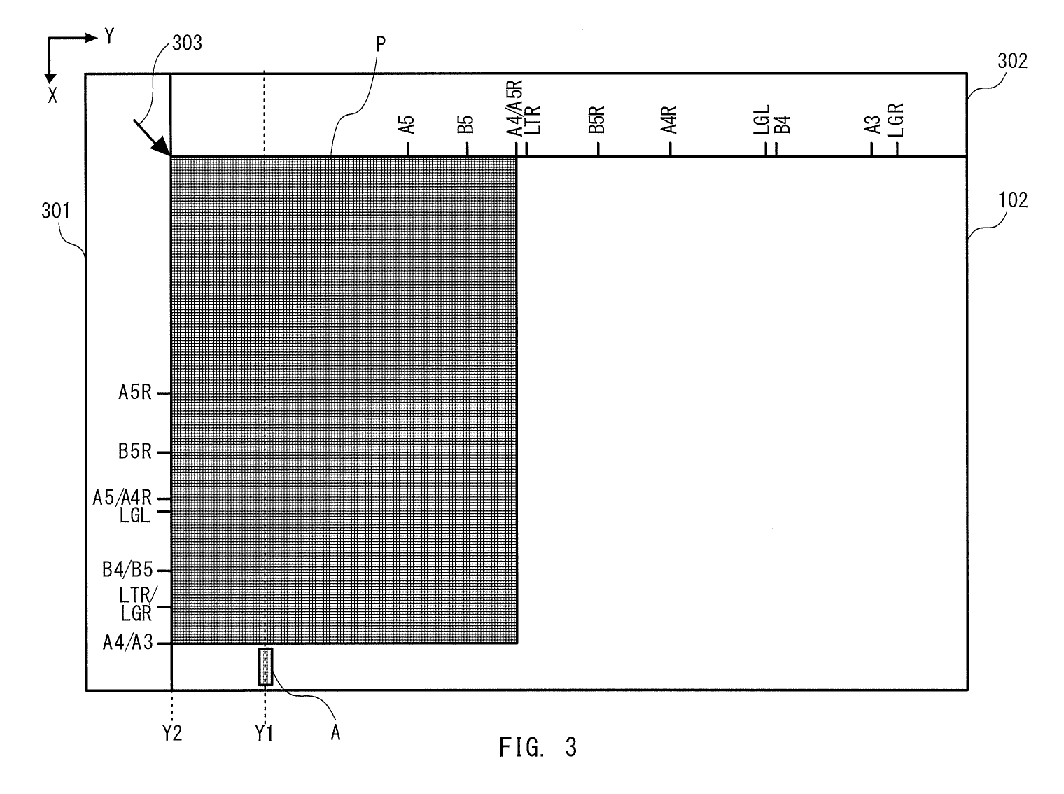

FIG. 3 is a schematic view for illustrating the image reading apparatus 10 as viewed from the top under a state in which the platen 104 is opened. A region 301 of FIG. 3 is a main scanning original size index. A region 302 of FIG. is a sub-scanning original size index. A reference position 303 indicated by an arrow in FIG. 3 is a reference position used when the original P is placed on the original table glass 102. In this case, the main scanning direction is a direction that is orthogonal to the sub-scanning direction (Y-axis direction), and corresponds to an X-axis direction of FIG. 3.

The original P to be read is placed on the original table glass 102 so that an upper left corner of the original P matches the reference position 303. FIG. 3 is an illustration of a state in which the A4-size original P is placed on the original table glass 102. Further, a position Y1 of FIG. 3 is an original size detection position, which is set to a position separated from an original reading start position Y2 by a predetermined amount. Further, a region A of FIG. 3 represents a region outside a maximum standard size in a direction (main scanning direction) intersecting with the direction (sub-scanning direction) in which the reading unit 103 is moved. Now, a reading operation to be performed by the image reading apparatus 10 is described.

The image reading apparatus 10 moves the reading unit 103 to the original size detection position Y1 when the platen open/close detection sensor 107 detects that the platen 104 is opened, that is, detects the change from the closed state to the open state.

When the platen open/close detection sensor 107 detects that the platen 104 is closed, that is, detects the change from the open state to the closed state, the image reading apparatus 10 turns on the illumination units 201a and 201b. Then, the image reading apparatus 10 moves the reading unit 103 from the original size detection position Y1 to the original reading start position Y2.

At this time, the image reading apparatus 10 causes the reading unit 103 to read image data of the original P for one line or a plurality of lines in the main scanning direction. A length in the main scanning direction that can be read by the reading unit 103 (readable main scanning length) is, for example, from the reference position 303 to an end portion of the maximum standard size outside region A.

The image reading apparatus 10 detects an original edge in the main scanning direction based on the read image data. Further, the image reading apparatus 10 performs protruding original determination (determination on whether or not an original P having a size that protrudes from the original table glass 102 is placed), which is described later, based on the image data of the maximum standard size outside region A. The illumination units 201a and 201b are turned on after the platen 104 is closed, and hence the light radiated from the illumination units does not reach the user's eyes.

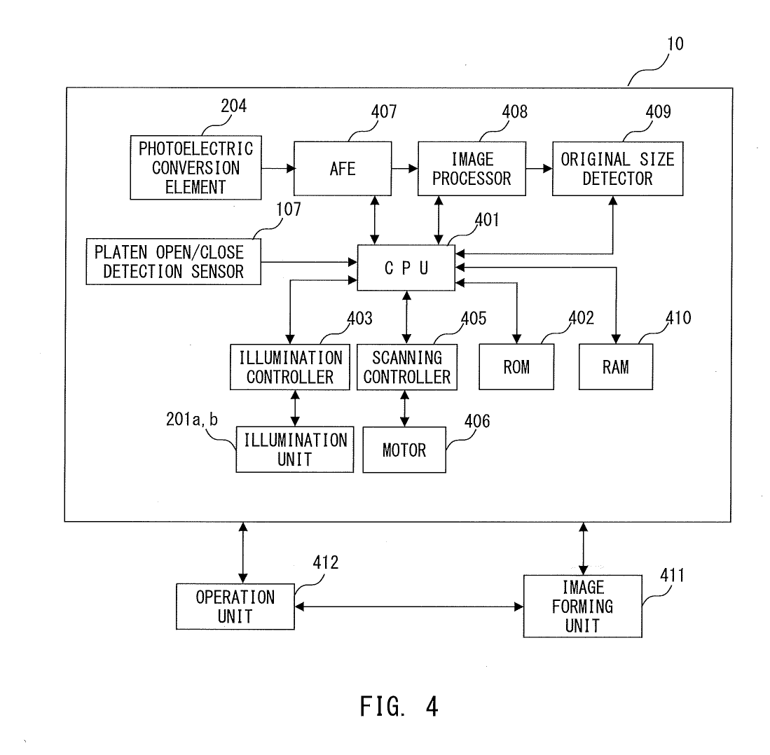

FIG. 4 is a block diagram for illustrating the functional configuration of the image forming system 152. The image reading apparatus 10 includes a central processing unit (CPU) 401, a read only memory (ROM) 402, an illumination controller 403, a scanning controller 405, a motor 406, an analog front end (AFE) 407, and an image processor 408. The image reading apparatus 10 further includes an original size detector 409 and a random access memory (RAM) 410.

The CPU 401 executes a program stored in the ROM 402 to control each functional unit of the image reading apparatus 10. The RAM 410 is used to temporarily or permanently store data to be used by the CPU 401.

The illumination controller 403 controls the operation of turning on or off the illumination units 201a and 201b.

The scanning controller 405 transmits a drive signal to the motor 406 to move the reading unit 103 in the sub-scanning direction.

The photoelectric conversion element 204 converts the received image data into an electrical signal.

The AFE 407 subjects the analog signal acquired from the photoelectric conversion element 204 to sample-hold processing, offset processing, gain processing, or other analog processing. The AFE 407 performs A/D conversion of converting the signal subjected to the analog processing into a digital signal, and outputs the processed signal to the image processor 408.

The image processor 408 subjects the image data acquired from the AFE 407 to predetermined digital image processing, and outputs the resultant to the original size detector 409 and the CPU 401.

The original size detector 409 determines whether or not a protruding original is placed based on the image data output from the image processor 408. The original size detector 409 detects the original edge (original end) based on the image data, and determines the original size based on the edge position. After performing predetermined processing, the image reading apparatus 10 starts the original size detection, which is triggered by detection of the closed state of the platen 104 by the platen open/close detection sensor 107.

The image forming unit 411 forms an image on a recording medium based on the image data received from the image processor 408.

An operation unit 412 is an input/output device including, for example, a monitor for information display and various operation keys including a start button for issuing an instruction to start reading. The operation unit 412 displays information to the user and receives an instruction from the user.

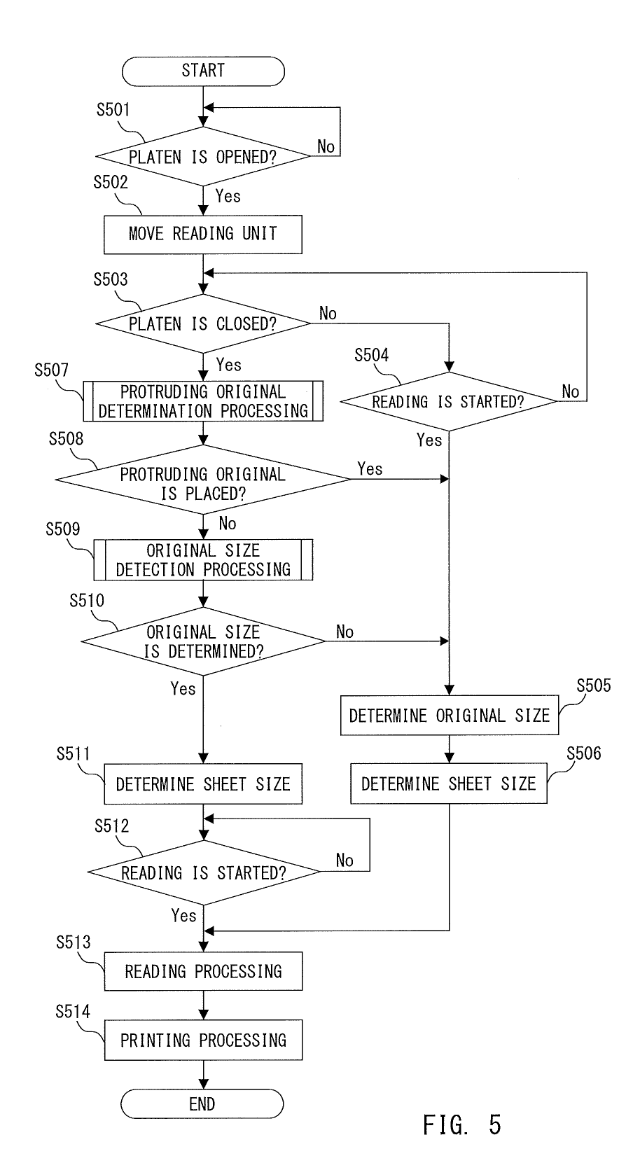

FIG. 5 is a flow chart for illustrating an example of a processing procedure from original reading to image formation in the image forming system 152. Each step of processing illustrated in FIG. 5 is mainly executed by the CPU 401.

The CPU 401 determines whether or not the platen 104 is changed from the closed state to the open state based on the output result of the platen open/close detection sensor 107 (Step S501). When the CPU 401 determines that the platen 104 is changed to the open state (Step S501: Yes), the CPU 401 moves the reading unit 103 to the original size detection position Y1 (Step S502).

The CPU 401 determines whether or not the platen 104 is changed from the open state to the closed state based on the output result of the platen open/close detection sensor 107 (Step S503).

When the CPU 401 determines that the state of the platen 104 is not changed (Step S503: No), the CPU 401 determines, for example, whether or not the start button of the operation unit 412 is pressed to issue an instruction to start reading (Step S504).

When the CPU 401 determines that the start button is not pressed (Step S504: No), the CPU 401 returns to the processing of Step S503. Otherwise (Step S504: Yes), the original size is undetermined, and hence the CPU 401 determines the original size through manual input via the operation unit 412 or determines the original size to the maximum standard size (Step S505). When the original size is determined through manual input, the CPU 401 presents, to the user, information for urging the user to input the original size. The CPU 401 determines the sheet size based on the original size determined in the processing of Step S505 (Step S506).

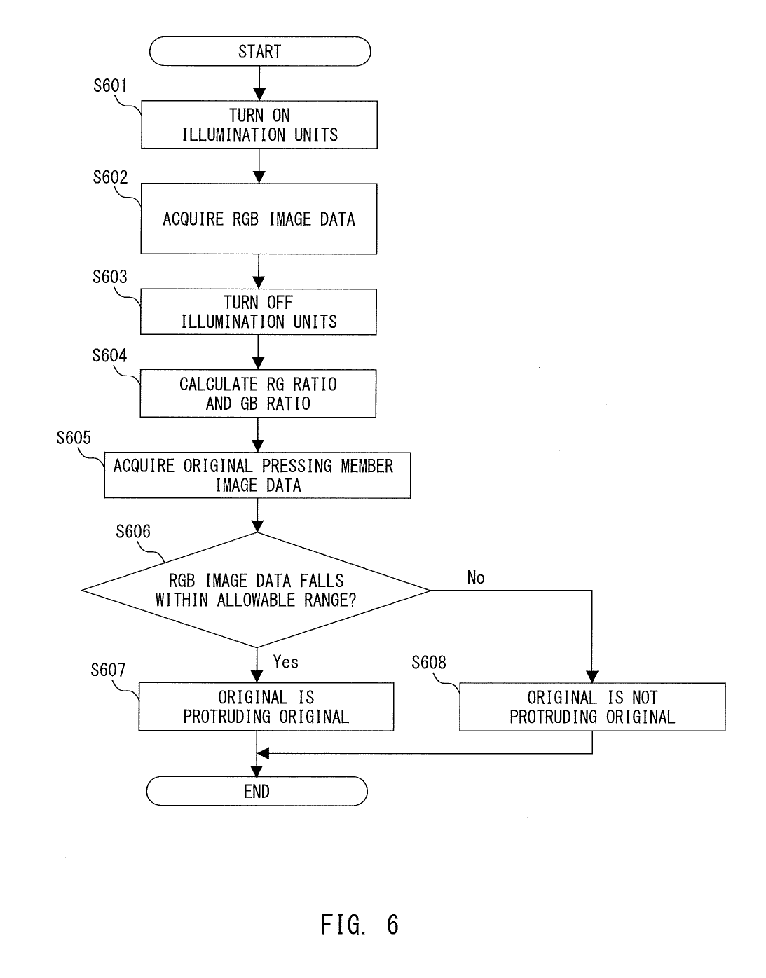

When the CPU 401 determines that the state of the platen 104 is changed (Step S503: Yes), the CPU 401 performs protruding original determination processing (Step S507). In the protruding original determination processing, the reading unit 103 turns on the illumination units 201a and 201b, and reads the original at the original size detection position Y1. The CPU 401 determines whether or not the original is a protruding original based on image data of a plurality of colors read from the maximum standard size outside region A, which is included in the image data output from the image processor 408. Details of the protruding original determination processing are described later with reference to FIG. 6.

The CPU 401 determines whether or not a protruding original is placed on the original table glass 102 based on the result of the protruding original determination processing (Step S508). When the CPU 401 determines that the protruding original is placed on the original table glass 102 (Step S508: Yes), the CPU 401 shifts to the processing of Step S505.

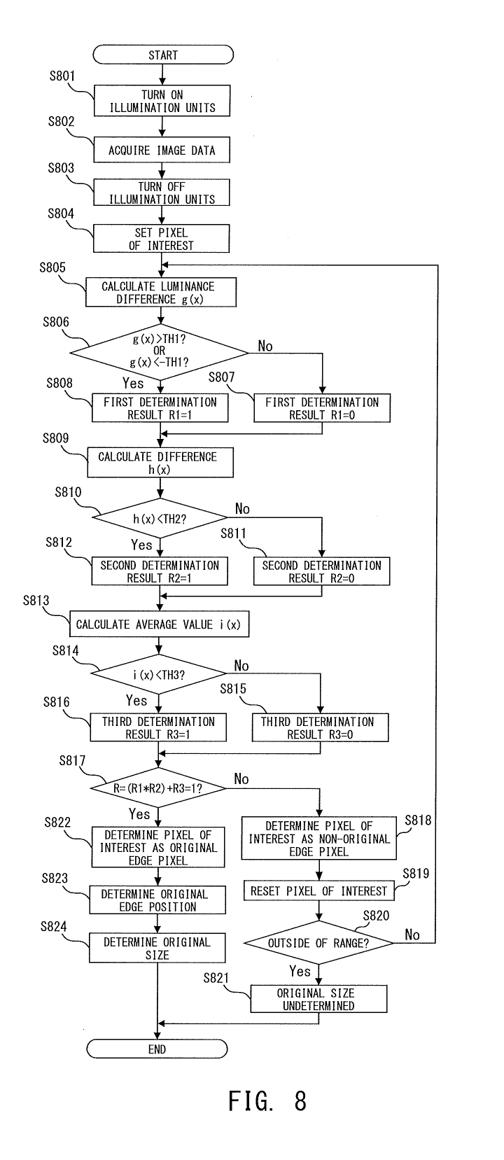

When the CPU 401 determines that a protruding original is not placed on the original table glass 102 (Step S508: No), the CPU 401 performs original size detection processing (Step S509). The original size detection processing is performed based on the image data read while the reading unit 103, which has turned on the illumination units 201a and 201b, is moved from the original size detection position Y1 to the original reading start position Y2. Details of the original size detection processing are described later with reference to FIG. 8.

The CPU 401 determines whether or not the original size is determined by the original size detection processing (Step S510). When the original size is not determined (Step S510: No), the CPU 401 shifts to the processing of Step S505. When the original size is determined (Step S510: Yes), the CPU 401 determines the sheet size to be used for printing based on the original size (Step S511).

The CPU 401 determines whether or not the instruction to start reading is issued (Step S512). When the CPU 401 determines that the instruction to start reading is issued (Step S512: Yes), the CPU 401 sets a reading region corresponding to the original size to perform reading processing of reading the image data of the original (Step S513). The CPU 401 executes printing processing of copying the image data of the original, which is read in the processing of Step S513, onto a sheet (Step S514).

In the processing of Step S509, the reading unit 103 reads one line or a plurality of lines between the original size detection position Y1 and the original reading start position Y2. In contrast, in the processing of Step S513, the reading unit 103 reads the entire original size region determined in the processing of Step S509. Further, the image data read by the reading processing is transmitted to the image forming unit 411 via the image processor 408.

FIG. 6 is a flow chart for illustrating details of the processing of Step S507 (protruding original determination processing) illustrated in FIG. 5. Each step of processing illustrated in FIG. 6 is mainly executed by the CPU 401. In the protruding original determination processing, it is required to read the image data of a plurality of colors from the maximum standard size outside region A. In the first embodiment, an RGB color system is given as an example, but, for example, an XYZ color system or an L*a*b* color system may be used instead.

The CPU 401 turns on the illumination units 201a and 201b (Step S601). The CPU 401 acquires each of R image data, G image data, and B image data (RGB image data) in the maximum standard size outside region A as acquired values (Step S602). The R image data, the G image data, and the B image data (image data in the maximum standard size outside region A) are represented by dat_R, dat_G, and dat_B, respectively.

The CPU 401 turns off the illumination units 201a and 201b (Step S603). The CPU 401 calculates an RG ratio (dat_RG) and a GB ratio (dat_GB) from the RGB image data acquired in the processing of Step S602 (Step S604). The values of dat_RG and dat_GB are not limited to ratios, and may be an RG difference and a GB difference.

The CPU 401 acquires RGB image data of the original pressing member 105 in the maximum standard size outside region A (color data of the original pressing member) as reference values (Step S605). The color data of the original pressing member is stored in a storage unit, for example, the RAM 410 in advance at the time of factory shipment or the like. The R image data, the G image data, the B image data (color data of the original pressing member), and the ratios at this time are represented by ref_R, ref_G, ref_B, ref_RG, and ref_GB.

The CPU 401 compares the acquired values of the RGB image data, which are acquired in the processing of Step S602, with the reference values read out in the processing of Step S605 (Step S606). Specifically, the CPU 401 provides, with the ref value serving as the center, an allowable range of ±s % to each of ref_R, ref_G, and ref_B and an allowable range of ±t % to each of ref_RG and ref_GB, and determines whether or not each dat value is included in each allowable range.

That is, the CPU 401 determines whether or not the following expressions are satisfied.

ref_R·(1−s/100)≤dat_R≤ref_R·(1+s/100)

and

ref_G·(1−s/100)≤dat_G≤ref_G·(1+s/100)

and

ref_B·(1−s/100)≤dat_B≤ref_B·(1+s/100)

and

ref_RG·(1−t/100)≤dat_RG≤ref_RG·(1−t/100)

ref_GB·(1−t/100)≤dat_GB≤ref_RG·1+t/100)

The reason why the allowable range is provided to each ref value is to prevent false determination due to reading variation. The original pressing member 105 and the original P are different in materials and surface properties, and thus are also different in image data. For example, when a protruding original is placed on the original table glass 102, the original P is present in the maximum standard size outside region A. In this state, a difference exceeding the allowable range is caused between the dat value and the ref value. On the other hand, when a protruding original is not placed on the original table glass 102, the original pressing member 105 is present in the maximum standard size outside region A. In this state, the ref value and the dat value are substantially the same even when the reading variation occurs. As the color data of the original pressing member 105, L*a*b* values or XYZ values may be used instead.

When the CPU 401 determines that the RGB image data falls within the allowable range as a result of comparison (Step S606: Yes), the CPU 401 determines that the original P placed on the original table glass 102 is a protruding original (Step S607). That is, in this case, a protruding original is placed on the original table glass 102. Otherwise (Step S606: No), the CPU 401 determines that the original P placed on the original table glass 102 is not a protruding original (Step S608). That is, in this case, a protruding original is not placed on the original table glass 102.

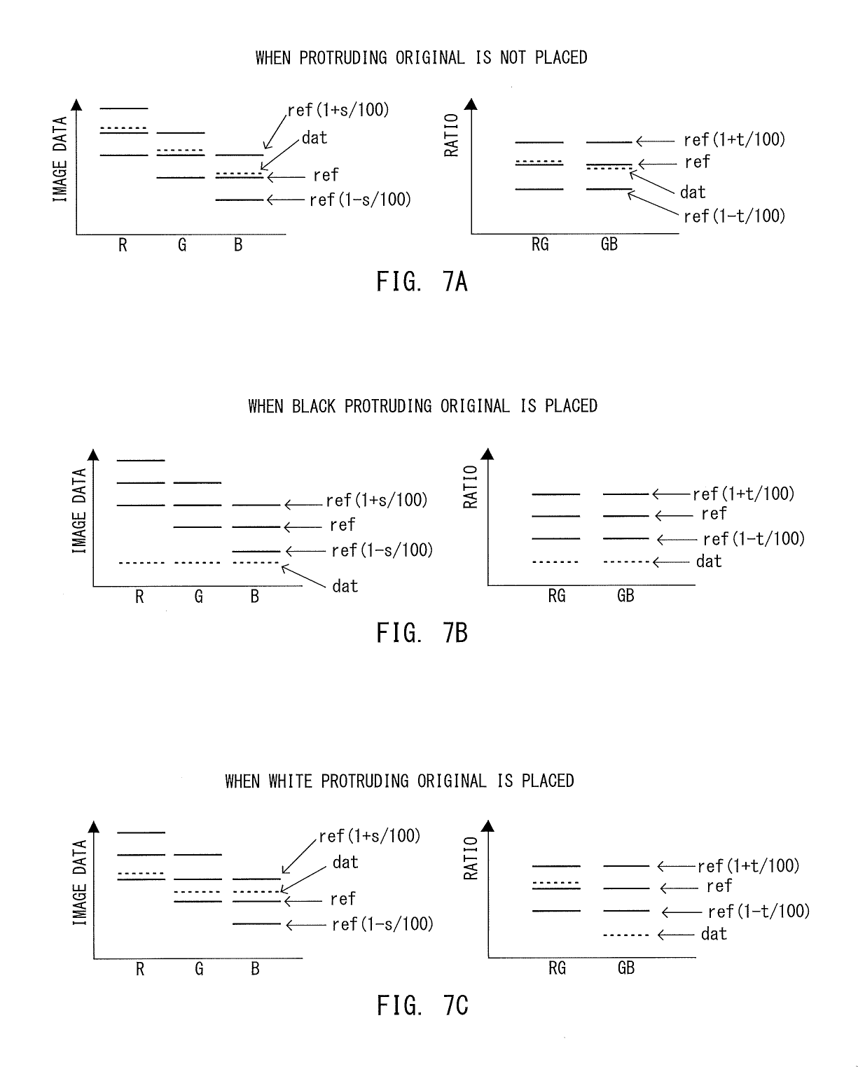

FIG. 7A to FIG. 7C are graphs for showing comparison between the dat value and the ref value in the protruding original determination processing. With reference to the graphs, description is given of a reason why not the respective R image data, G image data, and B image data themselves, which are output values of a plurality of read colors, but the ratios (rates) of the output values are compared in the present invention.

As shown in FIG. 7A, when a protruding original is not placed, the dat value falls within the allowable range even when the read image data has variation. As shown in FIG. 7B, when a protruding original that has a color that is obviously different from that of the original pressing member 105, for example, a black protruding original is placed, the RGB image data, which corresponds to the dat value, itself has a value that is obviously deviated from the allowable range.

As shown in FIG. 7C, when a protruding original that has a color that is close to that of the original pressing member 105, for example, a white protruding original is placed, strictly speaking, the RGB image data, which corresponds to the dat value, itself is different from the ref value. However, the allowable range is provided, and hence the RGB image data, which corresponds to the dat value, itself falls within the allowable range.

Therefore, when comparison is made only using the RGB image data, even when a white protruding original is placed in actuality, it is falsely determined that the determination result is “protruding original is not placed”.

When a white protruding original is placed on the original table glass 102, the RGB image data corresponding to the dat value falls within the allowable range of the ref value, but shows a different tendency from the ref value due to the differences in materials and surface properties between the original and the original pressing member 105. For example, dat_G is a value in the vicinity of the lower limit in the allowable range, and dat_B is a value in the vicinity of the upper limit in the allowable range. That is, the ratio between dat_G and dat_B is a value that is significantly different from the ratio between ref_G and ref_B. In view of this, not only the respective R image data, G image data, and B image data themselves but the ratios are compared to improve the determination accuracy in the protruding original determination.

FIG. 8 is a flow chart for illustrating details of the processing of Step S509 (original size detection processing) illustrated in FIG. 5. This processing is performed when it is determined that a protruding original is not placed in the protruding original determination processing (FIG. 5: Step S507). Each step of processing illustrated in FIG. 8 is mainly executed by the CPU 401.

The CPU 401 turns on the illumination units 201a and 201b (Step S801). The CPU 401 acquires the image data of the original for one line in the main scanning direction (Step S802). The CPU 401 turns off the illumination units 201a and 201b (Step S803).

The CPU 401 sets, as a pixel of interest, a pixel on the outermost side in an original edge detection range in the main scanning direction (Step S804). The original edge detection range in the main scanning direction is, for example, a range from a position on the inner side of the minimum standard size by a predetermined amount to a position on the outer side of the maximum standard size by a predetermined amount.

The CPU 401 sets a main scanning position of the pixel of interest as x and a luminance value of the pixel of interest as f(x). Then, the CPU 401 uses a first distance H1 to calculate a luminance difference g(x) of pixels that are present at a position x+H1 and pixels that are present at a position x-H1, which are separated from the pixel of interest by the first distance H1 in the main scanning direction (Step S805). The luminance difference g(x) can be calculated by Expression (1). In the first embodiment, as the luminance value, among the R image data, the G image data, and the B image data, the G image data is used. As luminance data, other image data may be used instead.

g(x)=f(x+H1)−f(x−H1) Expression (1)

The CPU 401 compares the luminance difference g(x) calculated in the processing of Step S805 with a first threshold value TH1 to determine whether the luminance difference g(x) is larger than a first threshold value TH1 with a plus sign in front (+TH1) or is smaller than a first threshold value TH1 with a minus sign in front (−TH1) (Step S806). That is, in this step, the CPU 401 determines whether or not an absolute value of the luminance difference g(x) is larger than the first threshold value TH1.

For example, the light from the illumination units 201a and 201b is obliquely radiated to the original P. A shadow may be caused at the original edge depending on the thickness of the original P. Thus, a luminance difference is caused between the original edge and the original pressing member 105 due to the shadow. Step S806 is processing for detecting this luminance difference.

Further, in the case of the original edge, the absolute value of the luminance difference g(x) is larger than the first threshold value TH1. In the case of the original pressing member 105 without the original, the absolute value of the luminance difference g(x) is smaller than the first threshold value TH1. The first threshold value TH1 is desired to be a small value so as to support even an original having a small basis weight to cause less shade.

When the absolute value of the luminance difference g(x) is equal to or smaller than the first threshold value TH1 (Step S806: No), the CPU 401 sets a first determination result R1 to “0” (Step S807). When the absolute value of the luminance difference g(x) is larger than the first threshold value TH1 (Step S806: Yes), the CPU 401 sets the first determination result R1 to “1” (Step S808). The determination from the processing of Step S805 to the processing of Step S808 is herein referred to as “first determination”.

In the first determination, when the pixel of interest is a pixel of the original edge, |g(x)|>TH1 is obtained, and thus the first determination result R1 is “1”. Further, when the pixel of interest is a pixel of the original pressing member 105 without the original, |g(x)|<TH1 is obtained, and thus the first determination result R1 is “0”. Also, when the pixel of interest is a pixel of dust, hair, or other dirt, |g(x)|>TH1 is obtained, and thus the first determination result R1 is “1”.

The CPU 401 uses a second distance H2 that is larger than the first distance H1 to calculate a difference h(x) between the maximum luminance value and the minimum luminance value of pixels that are present within a range to pixels separated from the pixel of interest by the second distance in the main scanning direction (Step S809). The difference h(x) can be calculated by Expression (2).

h(x)=max(f(x−H2), . . . , f(x), . . . , f(x+H2))−min(f(x−H2), . . . , f(x), . . . , f(x+H2)) Expression (2)

The CPU 401 determines whether or not the difference h(x), which is calculated in the processing of Step S809, is smaller than a second threshold value TH2 (Step S810). For example, the shadow caused at the original edge and dust, hair, or other dirt often has a difference in feature of luminance. The former is not a clear shadow but a blurred shadow due to the influence of diffusion light of the illumination units 201a and 201b. Therefore, the luminance is not so low. The latter has a low luminance because the dirt itself is often dark. Therefore, the difference h(x) is small in the former, and the difference h(x) is large in the latter. The CPU 401 can distinguish (recognize) those two by setting an appropriate threshold value.

When the CPU 401 determines that the difference h(x) is equal to or larger than the second threshold value TH2 (Step S810: No), the CPU 401 sets a second determination result R2 to “0” (Step S811). When the CPU 401 determines that the difference h(x) is smaller than the second threshold value TH2 (Step S810: Yes), the CPU 401 sets the second determination result R2 to “1” (Step S812). The determination from the processing of Step S809 to the processing of Step S812 is herein referred to as “second determination”.

In the second determination, when the pixel of interest is the original edge pixel, h(x)<TH2 is obtained due to the blurred shadow, and the second determination result R2 is “1”. Further, when the pixel of interest is a pixel of dust, hair, or other dirt, h(x)TH2 is obtained, and the second determination result R2 is “0”.

The first determination and the second determination have a large difference in a range from the pixel of interest. That is, the second distance H2 is required to be larger than the first distance H1 (H2>H1). In the following case, it is assumed that H2=H1 and a determination is executed such that the first determination and the second determination is combined. This means that the determination result is set to “1” only when the difference in luminance value is between TH1 and TH2, the original edge and the dust, hair, or other dirt cannot be distinguished. This is due to the fact that the dust, hair, or other dirt has low luminance, however, the luminance is not abruptly decreased, and a part with a gentle luminance change always appears. Thus, when the first determination and the second determination are executed in the same range, the determination result does not change between the original edge part and the part with a gentle luminance change of the dust, hair, or other dirt.

Therefore, the image reading apparatus 10 according to the first embodiment sets the range of the second determination to be larger than that of the first determination so as to include even the part with a low luminance of the dust, hair, or other dirt as a target for calculating the difference h(x). In this manner, the determination results can be made different therebetween, and the CPU 401 can distinguish those two parts.

The CPU 401 uses a third distance H3 to calculate an average value i(x) of luminance values of pixels present within a range to pixels each separated from the pixel of interest by the third distance in the main scanning direction (Step S813). The average value i(x) can be calculated by Expression (3).

i(x)=ave(f(x+H3), . . . , f(x), . . . , f(x−H3)) Expression (3)

The CPU 401 determines whether or not the average value i(x) calculated in the processing of Step S813 is smaller than a third threshold value TH3 (Step S814). For example, in the case of an original like a black original having no margin, in the vicinity of the original edge, an average value of the luminance values of pixels present in a range that is large to some extent in the main scanning direction is small. This is because the luminance value at the end portion of the black original is dominant. Meanwhile, in the case of dust, hair, or other dirt, a large average value is obtained. This is because dust, hair, or other dirt is often small or often has a streak shape, and hence, when the average value of the luminance values is calculated in a range that is large to some extent, only small influence is caused by the luminance of the dirt, and the white luminance of the original pressing member 105 is dominant. Therefore, the CPU 401 can distinguish (recognize) the two cases by setting an appropriate threshold value.

When the CPU 401 determines that the average value i(x) is equal to or larger than the third threshold value TH3 (Step S814: No), the CPU 401 sets a third determination result R3 to “0” (Step S815). Further, when the average value i(x) is smaller than the third threshold value TH3 (Step S814: Yes), the CPU 401 sets the third determination result R3 to “1” (Step S816). The determination from the processing of Step S813 to the processing of Step S816 is herein referred to as “third determination”.

In the third determination, when the pixel of interest is a pixel of the original edge of the black original, i(x)<TH3 is obtained, and thus the third determination result R3 is “1”. Further, when the pixel of interest is a pixel of dust, hair, or other dirt, i(x)>TH3 is obtained, and thus the third determination result R3 is “0”.

The CPU 401 determines whether or not a sum R (R=(R1*R2)+R3) of the product of the first determination result R1 and the second determination result R2 and the third determination result R3 is “1” (Step S817). For example, in the case of the original edge having a margin, R1=1, R2=1, and R3=0 are obtained, and hence the sum R of the product of the first determination result R1 and the second determination result R2 and the third determination result R3 is “1”. In the case of dust, hair, or other dirt, R1=1, R2=0, and R3=0 are obtained, and hence the sum R of the product of the first determination result R1 and the second determination result R2 and the third determination result R3 is “0”. In the case of the original edge having no margin, R1=1, R2=0, and R3=1 are obtained, and hence the sum R of the product of the first determination result R1 and the second determination result R2 and the third determination result R3 is “1”.

When the CPU 401 determines that the value of R is not “1” (Step S817: No), the CPU 401 determines the pixel of interest as a non-original edge pixel, that is, that the pixel of interest is not the edge pixel of the end portion of the original (Step S818). The CPU 401 newly sets a pixel on an inner side of the pixel of interest by one pixel in the main scanning direction as the pixel of interest (resets the pixel of interest) (Step S819), and determines whether or not the main scanning position of the pixel of interest is outside of a range of original edge detection in the main scanning direction (Step S820). When the main scanning position of the pixel of interest is outside of the range of original edge detection in the main scanning direction (Step S820: Yes), the CPU 401 determines that the original size is undetermined because the original P is not placed (Step S821). Otherwise (Step S820: No), the CPU 401 returns to the processing of Step S805.

When the CPU 401 determines that the value of R is “1” (Step S817: Yes), the CPU 401 determines the pixel of interest as an original edge pixel, that is, that the pixel of interest is the edge pixel of the end portion of the original (Step S822). The CPU 401 determines the main scanning position of the original edge pixel as an original edge position, that is, as the edge position of the original (Step S823). The CPU 401 determines the original size based on the original edge position (Step S824). In this case, it is assumed that the original P is placed so that the upper left corner thereof matches the reference position 303 of the original table glass 102. When the length from the reference position 303 to the original edge position matches or is close to any of respective standard sizes of the recording medium, the CPU 401 determines that a standard original is placed, and sets the standard size as the original size.

When the length from the reference position 303 to the original edge position does not match any of the respective standard sizes of the recording medium, the CPU 401 determines that a non-standard original is placed, and sets a closest standard size that is larger than the length from the reference position 303 to the original edge as the original size. In this manner, the information of the original can be prevented from being lacked when the non-standard original is printed.

In the original size detection processing described above, the image reading apparatus 10 according to the first embodiment executes original edge detection from the outer side to the inner side in the main scanning direction, and ends the original size detection processing after the original edge is detected. Thus, the image reading apparatus 10 is not affected by the image data in the original.

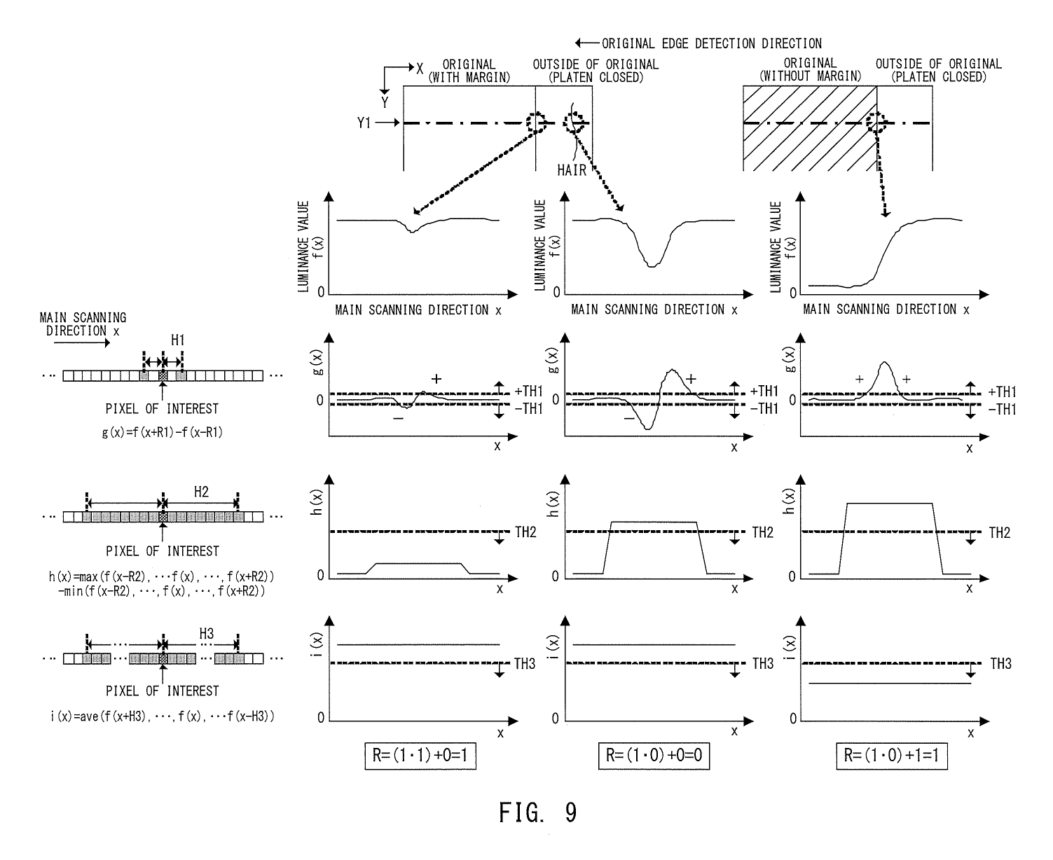

FIG. 9 is a graph for showing a relationship among a luminance value f(x) and g(x), h(x), and i(x) calculated in respective determinations in the original size detection processing. An arrow X of FIG. 9 represents the main scanning direction, and an arrow Y represents the sub-scanning direction.

The graphs shown in FIG. 9 are graphs of, from the left, a vicinity of an original edge position of an original having a margin, a vicinity of a position of hair, and a vicinity of an original edge position of a black original having no margin. The graphs shown in FIG. 9 are graphs of, in order from the top, f(x), g(x), h(x), and i(x).

The shadow caused at the original edge of the original having a margin is not a clear shadow but a blurred shadow due to the influence of diffusion light of the illumination units 201a and 201b, and hence the luminance is not so low. Therefore, the difference h(x) does not exceed the second threshold value TH2.

The hair itself is often dark, and hence the luminance is low, and the difference h(x) exceeds the second threshold value. Therefore, when the second determination of calculating h(x) is performed, it can be found that the original edge of the original having a margin and the hair are distinguished.

Hair often has a streak shape, and hence the white luminance value of the original pressing member 105 is dominant when the luminance value is acquired in a range that is large to some extent. Thus, i(x) exceeds the third threshold value.

In the original edge of the black original having no margin, the luminance value at the end portion of the black original is dominant when the luminance value is acquired in a range that is large to some extent. Thus, i(x) falls below the third threshold value. Therefore, when the third determination of calculating i(x) is performed, it can be found that the hair and the black original having no margin are distinguished.

As described above, the image reading apparatus 10 according to the first embodiment can determine whether or not a protruding original is placed with high accuracy without causing image deterioration.

### Second Embodiment

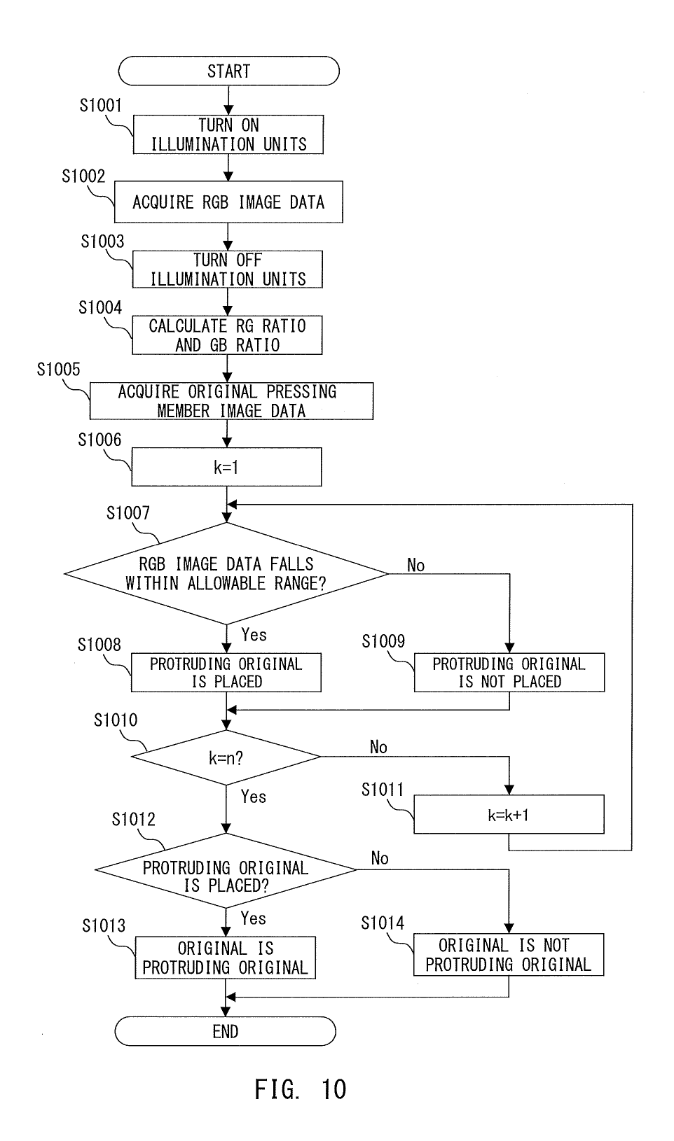

FIG. 10 is a flow chart for illustrating an example of a processing procedure of protruding original determination processing in an image reading apparatus according to a second embodiment of the present invention. Like functions and configurations as those already described in the first embodiment are denoted by like reference symbols, and description thereof is omitted herein.

In the protruding original determination processing of the second embodiment, the image reading apparatus performs the protruding original determination processing at a plurality of positions in the maximum standard size outside region A. When the image reading apparatus determines that a protruding original is placed at more than half of the plurality of positions, the image reading apparatus finally determines that a protruding original is placed. In this manner, the image reading apparatus can perform the protruding original determination with high accuracy even when dirt or the like adheres to a part of the maximum standard size outside region A.

Further, the image reading apparatus can perform the protruding original determination with high accuracy even when the original P is placed so that the upper left corner of the original P is slightly deviated from the reference position 303 and only a part of the original overlaps with the maximum standard size outside region A. In the protruding original determination processing, the image reading apparatus needs to read the image data of a plurality of colors from the maximum standard size outside region A. In the second embodiment, an RGB color system is given as an example, but, for example, an XYZ color system or an L*a*b* color system may be used instead.

The CPU 401 turns on the illumination units 201a and 201b (Step S1001). The CPU 401 acquires each of R image data, G image data, and B image data (RGB image data) in the maximum standard size outside region A at n positions (Step S1002). The R image data, the G image data, and the B image data are represented by dat_Rk, dat_Gk, and dat_Bk (k=1, . . . , n), respectively.

The CPU 401 turns off the illumination units 201a and 201b (Step S1003). The CPU 401 performs processing similar to the processing of Step S604 (FIG. 6) to calculate the RG ratio and the GB ratio (Step S1004). This processing differs from the processing of Step S604 in that as many pieces of data as the number of n positions are obtained.

The CPU 401 performs processing similar to the processing of Step S605 (FIG. 6) to acquire the RGB image data of the original pressing member 105 in the maximum standard size outside region A (color data of the original pressing member) (Step S1005). The color data of the original pressing member 105 is stored in the RAM 410 or the like in advance at the time of factory shipment or the like. The R image data, the G image data, the B image data (color data of the original pressing member), and the ratios at this time are represented by ref_Rk, ref_Gk, ref_Bk, ref_RGk, and ref_GBk. This processing differs from the processing of Step S605 in that as many pieces of data as the number of n positions are obtained.

The CPU 401 sets k to 1 (Step S1006). The CPU 401 performs comparison processing similar to the processing of Step S606 (FIG. 6) (Step S1007).

That is, the CPU 401 determines whether or not the following expressions are satisfied.

ref_Rk·(1−s/100)≤dat_Rk≤ref_Rk·(1+s/100)

and

ref_Gk·(1−s/100)≤dat_Gk≤ref_Gk·(1+s/100)

and

ref_Bk·(1−s/100)≤dat_Bk≤ref_Bk·(1+s/100)

and

ref_RGk·(1−t/100)≤dat_RGk≤ref_RGk·(1+t/100)

and

ref_GBk·(1−t/100)≤dat_GBk≤ref_GBk·(1+t/100)

When the CPU 401 determines that the RGB image data the comparison result falls within as a result of comparison (Step S1007: Yes), the CPU 401 determines that the protruding original is placed at the k-th position (Step S1008). Otherwise (Step S1007: No), the CPU 401 determines that the protruding original is not placed at the k-th position (Step S1009).

The CPU 401 determines whether or not k=n is satisfied (Step S1010). That is, the CPU 401 determines whether or not the protruding original determination is performed at the n positions. When k=n is not satisfied (Step S1010: No), the CPU 401 sets k to k+1, and returns to the processing of Step S1007 (Step S1011). Further, when k=n is satisfied (Step S1010: Yes), the CPU 401 determines whether or not the protruding original is determined to be placed at more than half of the n positions (Step S1012).

When the CPU 401 determines that the protruding original is determined to be placed at more than half of the n positions (Step S1012: Yes), the CPU 401 determines that the original placed on the original table glass 102 is a protruding original (Step S1013). That is, in this case, a protruding original is placed on the original table glass 102. Otherwise (Step S1012: No), the CPU 401 determines that the original is not a protruding original (Step S1014). That is, in this case, a protruding original is not placed on the original table glass 102.

In the embodiments described above, description is given of an example of a case in which the protruding original determination and the original size detection are performed mainly in the original main scanning direction, but the present invention is not limited thereto. For example, similar detection can be made even when the protruding original determination and the original size detection are performed in the sub-scanning direction.

### Other Embodiments

In the first and second embodiments, as illustrated in FIG. 2, description is given of an example of a configuration in which the reading unit 103 of the image reading apparatus 10 is moved in the sub-scanning direction. Even when the configuration of the reading unit or the like is of a type in which, for example, only the mirrors and the illumination units are moved and the photoelectric conversion element (CCD) is fixed, the present invention is applicable.

The image forming apparatus 10 according to each of the embodiments described above can determine whether or not a protruding original is placed with high accuracy without causing image deterioration. Each of the embodiments described above is given just for the purpose of describing the present invention more specifically, and the scope of the present invention is not limited by the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Embodiment(s) of the present invention can also be realized by a computer of a system or apparatus that includes one or more circuits (e.g., application specific integrated circuit (ASIC) or SOC (system on a chip)) for performing the functions of one or more of the above-described embodiment(s).

This application claims the benefit of Japanese Patent Application No. 2016-244055, filed Dec. 16, 2016 which is hereby incorporated by reference herein in its entirety.

What is claimed is:

1. An image reading apparatus, comprising:
an original table on which an original is to be placed;
an original pressing member configured to press the original toward the original table;
a sensor configured to read the original at a reading position to output a plurality of pieces of color data;
an illumination unit configured to illuminate the reading position;
a movement unit configured to move the reading position in a first direction;
a storage unit configured to store color data of the original pressing member; and
a processor configured to determine a size of the original based on the color data output from the sensor,
wherein the processor is configured to determine whether the original is protruding from a reading region based on the plurality of pieces of color data in a region outside the reading region in a second direction that is orthogonal to the first direction, the reading region corresponding to a maximum size among sizes that are able to be determined by the processor, and on the stored color data.

2. The image reading apparatus according to claim 1, further comprising a detection sensor configured to detect whether the original pressing member is in an open state or a closed state, wherein the processor is configured to determine, after an output result of the detection sensor represents that the original pressing member is in the closed state, whether the original is protruding from the reading region based on the plurality of pieces of color data that are output from the sensor in which the reading position is a predetermined position.

3. The image reading apparatus according to claim 2, wherein the illumination unit is configured to start illumination after the output result of the detection sensor represents that the original pressing member is in the closed state.

4. The image reading apparatus according to claim 1, wherein the processor is configured to determine the size of the original based on the color data output from the sensor after the processor determines that the original is not protruding from the reading region.

5. The image reading apparatus according to claim 1, wherein the processor is configured to determine the size of the original based on a user instruction in a case where the processor determines that the original is protruding from the reading region.

6. The image reading apparatus according to claim 1, wherein the processor is configured to set a maximum original size as the size of the original in a case where the processor determines that the original is protruding from the reading region.

7. The image reading apparatus according to claim 1, wherein the processor is configured to determine whether the original is protruding from the original table based on the color data output from the sensor and the color data of the original pressing member, which are obtained at a plurality of positions in a region outside a maximum standard size of the original.

8. The image reading apparatus according to claim 1, wherein the processor is configured to:
determine, in response to a reading result of the sensor, whether a predetermined pixel of interest is an edge pixel at an original end portion based on:
a result of first determination in which a difference in luminance value between pixels each separated from the predetermined pixel of interest in the second direction by a first distance is compared with a first threshold value;
a result of second determination in which a difference in luminance value between pixels present within a range to pixels each separated from the predetermined pixel of interest in the second direction by a second distance that is larger than the first distance is compared with a second threshold value; and
a result of third determination in which an average value of luminance values of pixels present within a range to pixels each separated from the predetermined pixel of interest in the second direction by a third distance is compared with a third threshold value; and
detect an edge position of the original based on a result of the determination to determine the size of the original based on a result of the detection.

9. The image reading apparatus according to claim 8, wherein the processor is configured to determine the size of the original based on the result of the detection in a case where the processor determines that the original is not protruding from the original table.

10. The image reading apparatus according to claim 1,
wherein the sensor is configured to read the original for at least one line in a main scanning direction, and
wherein the processor is configured to determine whether the original is protruding from the original table based on a result of the reading by the sensor.

11. A reading method, which is executed by an image reading apparatus,
the image reading apparatus comprising:
an original table on which an original is to be placed;
an original pressing member configured to press the original toward the original table;
a sensor configured to read the original at a reading position to output a plurality of pieces of color data;
an illumination unit configured to illuminate the reading position;
a movement unit configured to move the reading position in a first direction;
a storage unit configured to store color data of the original pressing member; and
a processor configured to determine a size of the original based on the color data output from the sensor,
the reading method comprising determining, by the processor, whether the original is protruding from a reading region based on the plurality of pieces of color data in a region outside the reading region in a second direction that is orthogonal to the first direction, the reading region corresponding to a maximum size among sizes that are able to be determined by the processor, and on the stored color data.

12. The reading method according to claim 11,
wherein the image reading apparatus further comprises a detection sensor configured to detect whether the original pressing member is in an open state or a closed state, and
wherein the reading method further comprises determining, by the processor, after an output result of the detection sensor represents that the original pressing member is in the closed state, whether the original is protruding from the reading region based on the plurality of pieces of color data that are output from the sensor in which the reading position is a predetermined position.

13. The reading method according to claim 12, further comprising starting, by the illumination unit, illumination after the output result of the detection sensor represents that the original pressing member is in the closed state.

14. The reading method according to claim 11, further comprising determining, by the processor, the size of the original based on the color data output from the sensor after determining that the original is not protruding from the reading region.

15. The reading method according to claim 11, further comprising determining, by the processor, the size of the original based on a user instruction in a case where determining that the original is protruding from the reading region.

16. The reading method according to claim 11, further comprising setting, by the processor, a maximum original size as the size of the original in a case where determining that the original is protruding from the reading region.

17. The reading method according to claim 11, further comprising determining, by the processor, whether the original is protruding from the original table based on the color data output from the sensor and the color data of the original pressing member, which are obtained at a plurality of positions in a region outside a maximum standard size of the original.

18. The reading method according to claim 11, further comprising:
determining, by the processor, in response to a reading result of the sensor, whether a predetermined pixel of interest is an edge pixel at an original end portion based on:
a result of first determination in which a difference in luminance value between pixels each separated from the predetermined pixel of interest in the second direction by a first distance is compared with a first threshold value; a result of second determination in which a difference in luminance value between pixels present within a range to pixels each separated from the predetermined pixel of interest in the second direction by a second distance that is larger than the first distance is compared with a second threshold value; and
a result of third determination in which an average value of luminance values of pixels present within a range to pixels each separated from the predetermined pixel of interest in the second direction by a third distance is compared with a third threshold value; and
detecting, by the processor, an edge position of the original based on a result of the determination to determine the size of the original based on a result of the detection.

19. The reading method according to claim 18, further comprising determining, by the processor, the size of the original based on the result of the detection in a case where determining that the original is not protruding from the original table.

20. The reading method according to claim 11, further comprising:
reading, by the sensor, the original for at least one line in a main scanning direction; and
determining, by the processor, whether the original is protruding from the original table based on a result of the reading by the sensor.
